(19) United States
(12) Patent Application Publication
(10) Pub. No.: US 2007/0290979 A1
(43) Pub. Date: Dec. 20, 2007

(54) Source drive amplifier for flat panel display

(75) Inventors: Cheung Fai Lee, Sheung Shui (HK); Yiu Sang Lei, Kwun Tong (HK)

Correspondence Address: Thomas E. Kocovsky, Jr.;FAY, SHARPE, FAGAN, MINNICH & McKEE, LLP, Seventh Floor, 1100 Superior Avenue, Cleveland, OH, 44114-2579, US

(73) Assignee: SOLOMON SYSTECH LIMITED, Hong Kong (HK)

(21) Appl. No.: 11/454,027

(22) Filed: Jun. 15, 2006

(51) Int. Cl. G09G 3/36

(52) U.S. Cl. 345/100

(57) ABSTRACT

An output buffer (100) for a TFT-LCD display device includes a push-pull output stage having a first device (Mp) for supplying current to an output (Vout) and a second device (Mn) for drawing current from the output. A first pre-amplifier (101) is coupled to an input (Vin) of the buffer for driving the first device to supply current to the output. A second pre-amplifier (102) is coupled to the input of the buffer for driving the second device to draw current from the output. A first switchable offset is associated with the first pre-amplifier (101) and a second switchable offset is associated with the second pre-amplifier (102). A switchable current source (Ip) is configured to supply current to the output and a switchable current sink (In) is configured to draw current from the output. A switching input Ø₁ configured to activate both the first switchable offset and the switchable current source, and a complementary switching input Ø₂ is configured to activate the second switchable offset and the switchable current sink.

### PURPOSE OF THE INVENTION

It is desired to produce a driving strategy for a source drive amplifier in flat-panel-display applications with advantages in small circuit area, low static power consumption, high output accuracy, and large driving capability at the same time.

### BACKGROUND

1. Field of the Invention

The present invention relates to a source drive amplifier of a flat panel display and, more particularly, to a source drive amplifier used in, for example, the driving circuit of a thin film transistor liquid crystal display.

2. Description of Related Art

The thin film transistor liquid crystal display (TFT-LCD) is known as an active array type display. The array is composed of a plurality of pixels (or dots), each having a driving electrode and a common electrode shared with the other pixels. The LCD is driven by an AC (alternating current) signal. In such an arrangement, if the voltage applied to the driving electrode is positive with respect to that of the common electrode when a first frame is displayed, the voltage applied to the driving electrode with respect to that of the common electrode is negative in the next successive frame. The voltage applied to the driving electrode is provided by a column driver, also known as a segment driver. The column (or source, as it is sometimes known) driver has multiple column (or source) cell driver units to provide drive outputs to multiple columns in the LCD.

There are two well-known common electrode implementations in TFT-LCD panels: static common electrode and dynamic common electrode. For static common electrode, the voltage applied to common electrode is static. If the voltage applied to the driving electrode is larger than the voltage applied to the common electrode, a positive voltage is applied with respect to the pixel. If the voltage applied to the driving electrode is smaller than the voltage applied to the common electrode, a negative voltage is applied with respect to the pixel.

FIG. 7 is a typical gamma curve with static common electrode scheme. The gamma curve indicates the relationship of output brightness (horizontal axis) of the display to the driver output voltage (vertical axis) of the column cell, or also called the source cell. The column (source) output voltage of the drivers is separated into a number of voltage levels (VGL0 to VGL63) and each level corresponds to a grey level of display brightness (GL0 to GL63), in the case of 6-bits image data. As shown in FIG. 7, all positive gamma voltages are higher than the common electrode voltage, while all negative gamma voltages are lower than the static common electrode voltage (VCOM).

For dynamic common electrode, the voltage applied to common electrode is an AC signal, which is represented as VCOMH or VCOML, being two voltage levels. If the odd lines of the first frame are driven by VCOMH, the even lines of the first frame are driven by VCOML. Then, the odd lines of the second frame are driven by VCOML, the odd lines of the second frame are driven by VCOMH. FIG. 8(a) is a typical gamma curve with dynamic common electrode scheme. As shown in FIG. 8(a), all positive gamma voltage are higher than common electrode VCOML, while all negative gamma voltage are lower than common electrode VCOMH.

Display image quality depends on the accuracy of the voltage levels (VGL0 to VGL63) corresponding to grey levels (GL0 to GL63) produced by the source drive units in the display driving electronics system. For the different implementations of the common electrodes for the display panel, there are three well-known driving methods used in the display driving electronic system: dot inversion driving, row inversion driving (or line inversion driving) and frame inversion driving.

In the dot inversion driving system, if the odd dots of the odd lines of the first frame are driven by a positive voltage with respect to the common electrode, the even dots of the odd lines of the first frame are driven by a negative voltage with respect to the common electrode. The odd dots of the even lines of the first frame are driven by a negative voltage with respect to the common electrode, and the even dots are driven by a positive voltage with respect to the common electrode. Then for the second frame, the odd dots of the odd lines are driven by a negative voltage with respect to the common electrode and the even dots are driven by a positive voltage with respect to the common electrode. Meanwhile, the odd dots of the even lines are driven by a positive voltage with respect to the common electrode, and the even dots are driven by a negative voltage with respect to the common electrode.

In the row inversion system, if all dots of the odd lines of the first frame are driven by a positive voltage with respect to the common electrode, all the dots of the even lines of the first frame will be driven by a negative voltage with respect to the common electrode. Then for the second frame, all dots of the odd lines are driven by a negative voltage with respect to the common electrode, and all dots of the even lines of the second frame are driven by a positive voltage with respect to the common electrode.

In the frame inversion system, all dots of the first frame are driven by a positive voltage with respect to the common electrode. Then all dots of the second frame are driven by a negative voltage with respect to the common electrode.

FIG. 9 is a schematic view showing the display driving electronics system for an active thin film liquid crystal display 904 with K columns by L rows. As shown in the figure, if there are K pixels in the horizontal direction, K channels of source drive units (SDUs) 902 are required for driving. In the vertical direction, a gate driver 905 is employed to drive the voltage on each scanning line sequentially, to turn on and off the TFT's 901 of the pixels on each row for sampling and holding the voltage level outputted by the SDU's 902.

FIG. 10 is a circuit diagram of the source drive unit 902 for a TFT-LCD with static common electrode implementation, which has a multiplexer (MUX) 911 controlled by a polarity switching signal PN for selecting either the output of a positive digital to analog converter (P-DAC) 912 or the output of a negative digital to analog converter (N-DAC) 913 to a voltage follower formed by an operational amplifier 914, thereby amplifying the driving ability to generate a driving output DRVO. The driving output DRVO is then supplied to a CMOS transmission gate 915 controlled by an output enable signal (OE) that gates the output DRVO to drive the voltage onto the VLCD pin for one column of the TFT-LCD panel. The operating waveforms for the circuit of FIG. 10 are illustrated in FIG. 11, wherein the P-DAC and N-DAC are controlled by input digital display image data so as to generate the corresponding driving voltage according to the driving method. The P-DAC and N-DAC digital to analog voltage relationships are as governed by the positive and negative gamma curves respectively. The outputs of the P-DAC and N-DAC are similar, but symmetric with respect to the common electrode, so as to satisfy the AC driving requirement.

The output voltages of the P-DAC and N-DAC are generally in the range from VSS+0.1V to VDD−0.1V. Therefore, the operational amplifier 914 used in the source drive unit 902 must have the capability of full rail-to-rail output voltage swing. When the output is higher than the voltage of the common electrode, a large current source capability is required so that a load capacitor, formed primarily by the layout parasitic capacitance on the panel of the thin film transistor liquid crystal display 904, is charged rapidly to a high voltage. When the output is lower than the voltage of the common electrode, a large current sink capability is required for discharging the high voltage of the load capacitor of the thin film transistor liquid crystal display 904 to a low voltage.

To match this requirement, the circuit of an operational amplifier used in a prior art source drive unit 902 is disclosed as shown in FIG. 12 (a detail description of such can be found in U.S. Pat. No. 6,731,170). Operation of the amplifier is put under the control of the PN signal. When PN selects the P-DAC 912, the operational amplifier is configured as FIG. 13 to drive the liquid crystal display pixel a positive voltage with respect to common electrode. When PN selects the N-DAC 913, the operational amplifier is configured as FIG. 14 to drive the liquid crystal display pixel a negative voltage with respect to common electrode. For the static common electrode case where all positive gamma voltages are always higher than common electrode and all negative gamma voltages are always lower than common electrode, the polarity switching control signal PN can be used to determine the configurations of the amplifier for it to perform as desired.

For the dynamic common electrode case, the desired polarity, positive or negative, of the drive amplifier is determined with respect to the dynamic common electrode voltage and the output voltages of individual columns before the output amplifier starts a new drive phase. The output voltages of individual columns at the start of a new drive phase depend on the previous data at individual columns and the effects of charge sharing. In many display driving schemes, in order to recycle electrical charges for power reduction and to promote drive uniformity, a charge sharing phase is often employed before the start of a new drive phase to equalize the voltages of individual columns by connecting all the columns together in sharing of electrical charges. Although the resultant voltage at the end of charge sharing is mid level on the average, the specific resultant level would be different each time, depending on the data of all the columns at each time. A prior deterministic control signal such as PN is not possible in general for driving schemes using dynamic common electrode or charge sharing.

A more detailed breakdown of the problem is as follows. In FIG. 8(b), a gamma curve shown by a solid line represents the negative gamma voltage with respected to common electrode VCOMH, while a gamma curve shown by a dotted line represents the positive gamma voltage with respected to common electrode VCOML. In the ideal case, VGL0 to VGL31 of the positive gamma voltages are higher than VGL31 to VGL63 of the negative gamma voltage and VGL0 to VGL31 of the negative gamma voltages are higher than VGL31 to VGL63 of the positive gamma voltage. In practice, due to the actual display panel characteristic requirements, the positive gamma curve and negative gamma curve are not symmetrical, e.g. the positive gamma curve may be shifted down a little bit like the adjusted dotted line in FIG. 8(b), resulting in inconsistent deviations from the exact relationship existed between the gamma voltages in the idea case. Furthermore, the voltage level after the charge sharing phase will be variable around VGL31 and VGL32 but will not be ideally in-between VGL31 and VGL32. From this detail analysis, because of these actual voltage variations, the use of a deterministic control signal deriving from a comparison of previous and present line data, such as PN in the prior art, will be problematic with errors in the selection making of the output buffer driving polarity for dynamic common electrode application.

FIG. 4(a) shows the basic structure of the driving strategy disclosed in the paper by P. C. Yu and J. C. Wu, “A class-B output buffer for flat-panel display column driver”, IEEE Journal of solid-state circuits, p116-119, vol.34, no.1, January 1999. The arrangement of FIG. 4(a) has a common source push-pull output stage. Two comparators Cmp1 and Cmp2 in the structure serve as controllers to switch the respective transistors Mp and Mn on or off, according to the difference between the output voltage Vout and the input voltage Vin. FIG. 4(c) shows the configuration when charging the load and FIG. 4(d) shows the configuration when discharging the load. When Vout<Vin, comparator Cmp1 will turn transistor Mp on and comparator Cmp2 will turn transistor Mn off. When Vout>Vin, comparator Cmp1 will turn transistor Mp off and comparator Cmp2 will turn transistor Mn on. Ideally, transistors Mp and Mn will not be on at the same time, preventing the undesirable occurrence of shot-through current. In practice, due to unavoidable small variations of device parameters over the silicon, around the cross-over region of Vin˜Vout, the comparators Cmp1 and Cmp2 will not be able to turn the transistors Mp or Mn completely off, leading to shot-through current because both transistors Mp and Mn will be conducting during this cross-over region.

To eliminate the shot-through current in the static state, offset voltages Vos are applied to the comparators Cmp1 and Cmp2 to offer a tolerance for process variations. When |Vin-Vout|<Vos, both transistors Mp and Mn are turned off, as seen in FIG. 4(b), to avoid the appearance of shot-through current. There is a tradeoff between the tolerance margin and output accuracy. A larger comparator offset voltage increases the robustness of the circuit against process variations, but an output error equal to the offset voltage is increased, as shown in FIG. 6(a).

FIG. 5(a) shows the basic structure of a modified driving strategy, which has been proposed to eliminate the output error caused by the offset voltage in the circuit of FIG. 4(a). A small auxiliary buffer, with no offset voltage, is added between the input and the output. This buffer can drive the output during the |Vin-Vout|<Vos condition, as seen in FIG. 5(b), to eliminate the output error. The addition of an auxiliary buffer increases the power consumption and the circuit size. To minimize the extra power consumption and to counter effects on the main push-pull output during the charging (seen in FIG. 5(c)) and the discharging (seen in FIG. 5(d)) transition periods, the auxiliary buffer cannot have a large driving capability. This results in slow response during the |Vin-Vout|<Vos condition, as indicated in FIG. 6(b) for the regions near V_high and V_low.

### SUMMARY OF THE INVENTION

It is an object of the present invention to substantially overcome or at least ameliorate one or more deficiencies of existing arrangements.

According to the present disclosure, switchable voltage offsets are used to accommodate process variations, the switching of the offsets being associated with the switching of current arrangements coupled to the output addresses shot-through current without a significant tradeoff of the output accuracy. The current arrangements provide biasing for the output stage to maintain output accuracy and stabilization at steady state.

In accordance with one aspect of the present disclosure there is provided a source drive amplifier comprising an output stage driven by an input differential gain stage having switchable offsets. The input differential gain stage drives the output stage according to the difference between the two input voltages, with the output voltage coupled to one of the inputs in a negative feedback manner. The output stage is a push-pull circuit that provides low output impedance and a large current-driving capability. Switchable current arrangements are coupled to the output and at least one switching input is configured to switch operation of the offsets and current arrangements based on the relative polarity of input and output.

In a specific implementation, disclosed is a drive amplifier for a display device. The drive amplifier includes a push-pull output stage having a first device for supplying current to an output and a second device for drawing current from the output. The amplifier has an input differential gain stage, in which a first differential pre-amplifier is coupled to an input for driving the first device to supply current to the output, while a second differential pre-amplifier is also coupled to the input for driving the second device to draw current from the output. A first switchable offset associated with the first pre-amplifier and a second switchable offset associated with the second pre-amplifier are also provided, as are a switchable current source configured to supply current to the output and a switchable current sink configured to draw current from the output. At least one switching input is configured to activate both the first switchable offset and the switchable current sink, and alternately both the second switchable offset and the switchable current source. The outputs of the pre-amplifiers in the input differential gain stage are desirably determined from a comparison of the input and output voltages of the drive amplifier.

Other aspects will be apparent from the following description.

### BRIEF DESCRIPTION OF THE DRAWINGS

FIG. 1 is a schematic circuit diagram of a source drive amplifier in accordance with the present disclosure;

FIG. 2 shows the amplifier of FIG. 1 when charging or driving the load;

FIG. 3 shows the amplifier of FIG. 1 when discharging the load;

FIGS. 4(a)-4(d) show a prior art amplifier in various modes of operation;

FIGS. 5(a)-5(d) show another prior art amplifier in various modes of operation;

FIGS. 6(a)-6(c) are comparative representations of performance of amplifiers of the prior art and in accordance with the present disclosure;

FIG. 7 is a gamma curve for a prior art common electrode TFT-LCD;

FIG. 8(a) is a gamma curve for a dynamic common electrode TFT-LCD;

FIG. 8(b) illustrates the asymmetry of gamma curves;

FIG. 9 is a schematic representation of the driving electronics of a prior art active thin film LCD and within which the presently described arrangements can be used;

FIG. 10 is a schematic representation of a prior art source drive unit that can be used in the arrangement of FIG. 9;

FIG. 11 shows operating waveforms for the circuit of FIG. 10;

FIG. 12 is a circuit diagram of a prior art amplifier that can be used for the drive buffer 914 of FIG. 10;

FIG. 13 shows the configuration of the amplifier of FIG. 12 when driving the LCD positive;

FIG. 14 shows the configuration of the amplifier of FIG. 12 when diving the LCD negative; and

FIG. 15 shows a configuration of a drive amplifier formed for use with the circuit of FIG. 1.

FIGS. 16(a) and 16(b) show the two cases of configuration of the circuit of FIG. 1 assuming that a wrong decision was made by the switchable offset control signal.

### DETAILED DESCRIPTION INCLUDING BEST MODE

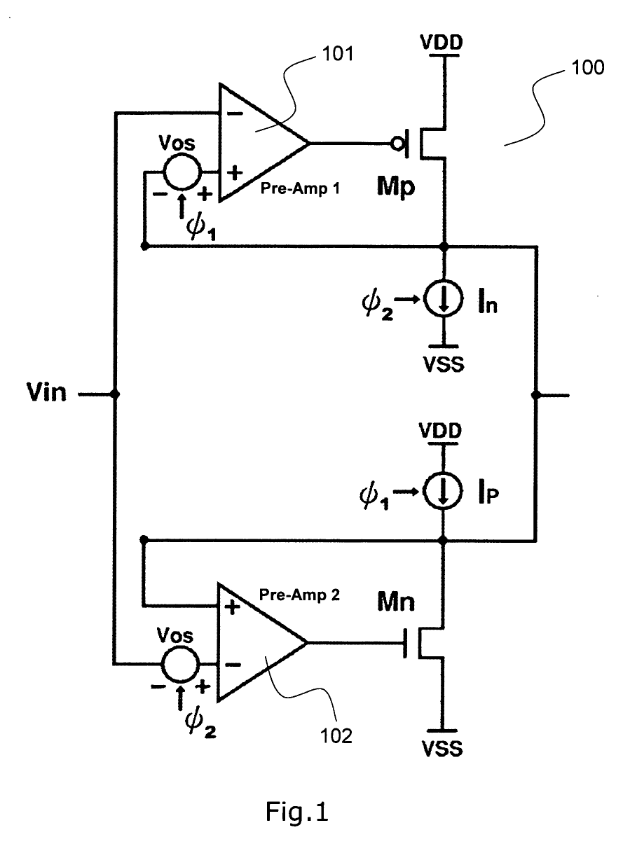

FIG. 1 shows a drive amplifier 100 according to the present disclosure and preferably configured for use in a source drive unit of a TFT-LCD arrangement. The drive amplifier 100 includes a complementary push-pull output stage arrangement of common-source connected output transistors Mp and Mn, whose drains couple to an output Vout. Such a configuration permits bidirectional supply of current from the drive amplifier 100 to a load. The transistors Mp and Mn are each driven by a corresponding differential pre-amplifier, 101 and 102 respectively. Both Mp and Mn can be implemented by either PMOS or NMOS. The pre-amplifiers 101 and 102 are each provided a switchable voltage offset Vos. The offset voltage of each pre-amplifier can be connected to either the non-inverting input or the inverting input of the pre-amplifier.

In the implementation in FIG. 1, Mn is a NMOS transistor and Mp is a PMOS transistor. The pre-amplifier 101 is configured to output a feedback controlled voltage to drive Mp when Vin>Vout+Vos. The pre-amplifier 102 is configured to output a feedback controlled voltage to drive Mn when Vin<Vout−Vos. The pre-amplifier 101 uses the configuration that connects the offset voltage to the non-inverting input. Therefore, the switchable offset voltage Vos is coupled between the non-inverting input of pre-amplifier 101 and Vout. The input Vin couples to the inverting input of pre-amplifier 101. The pre-amplifier 102 uses the configuration that connects the offset voltage to the inverting input. Therefore, the corresponding switchable voltage offset Vos is arranged between the inverting input of pre-amplifier 102 and an input Vin. The non-inverting input of pre-amplifier 102 connects to the output Vout.

A switchable current sink In is configured between the output Vout and a negative voltage supply Vss. A switchable current source Ip is configured between a positive voltage supply Vdd and the output Vout. The sink In will operate to draw current from the output whereas the source Ip will operate to supply current to the output. Complementary phase switching control signals Ø₁ and Ø₂ are provided. The offset to pre-amplifier 101 and the current source Ip are activated by signal Ø₁. The offset of pre-amplifier 102 and the current sink In are activated by signal Ø₂

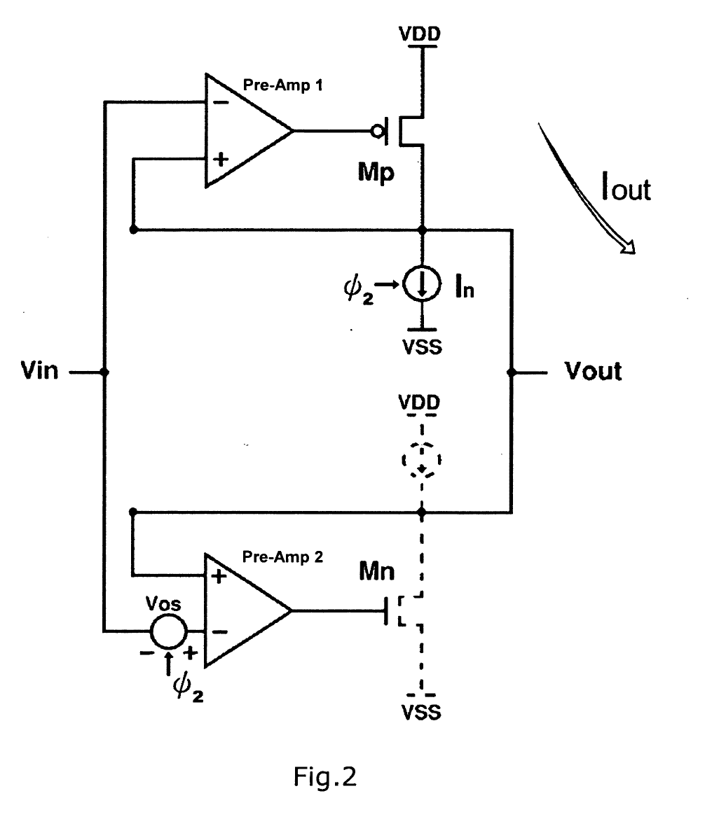

The operation of the driver amplifier 100 is as follows. For Vin>Vout, the non-active Ø₁ de-activates the offset to pre-amplifier 101 and bias source current Ip, while the active Ø₂ activates the offset to pre-amplifier 102 and bias sink current In. Pre-amplifier 101 turns on the transistor Mp, while pre-amplifier 102 turns off the transistor Mn. Regardless of any routine process parameters variation, the activated offset voltage Vos in pre-amplifier 102 provides a safety margin to keep Mn turned off as the output voltages reaches close to, even within a small Vos range of, the input Vin level, thereby preventing any short-through current from occurring. The effective circuit configuration of the driver amplifier 100 becomes as shown in FIG. 2 with Mp supplying current Iout to the load (ie. the TFT's of the pixels of the LCD 904) until the output Vout reaches the level of Vin. Active bias afforded by the current sink In keeps Vout stable and equal to Vin at steady state.

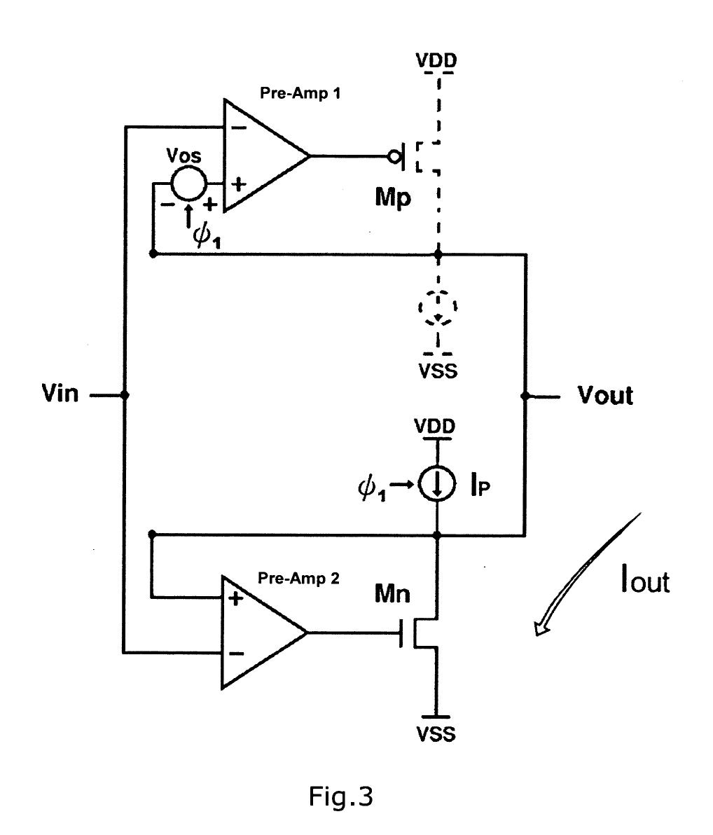

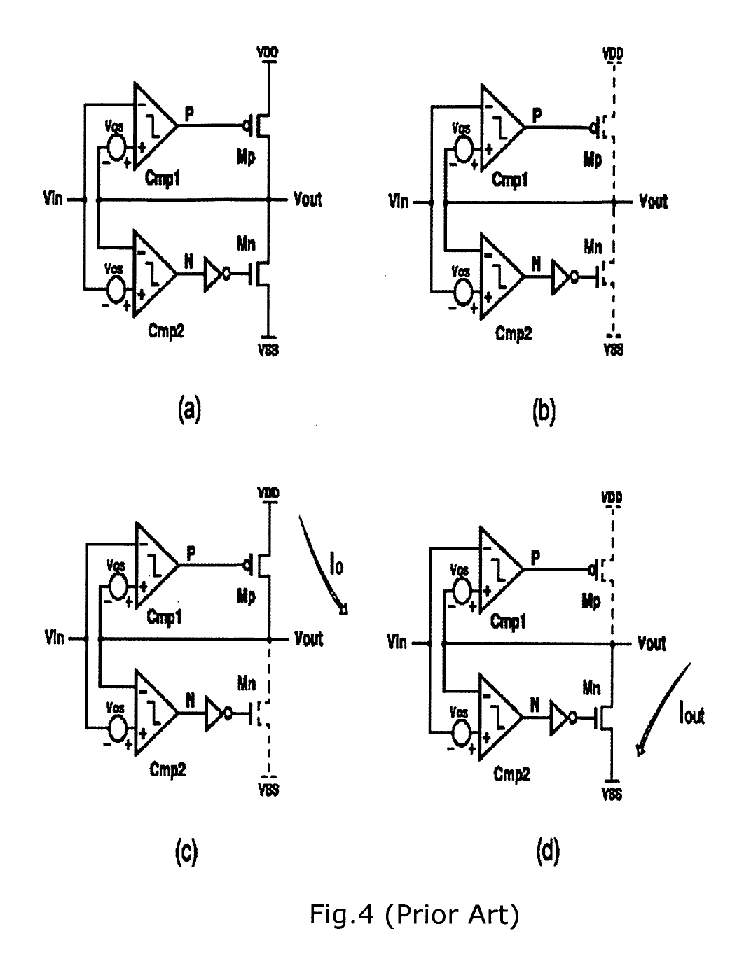

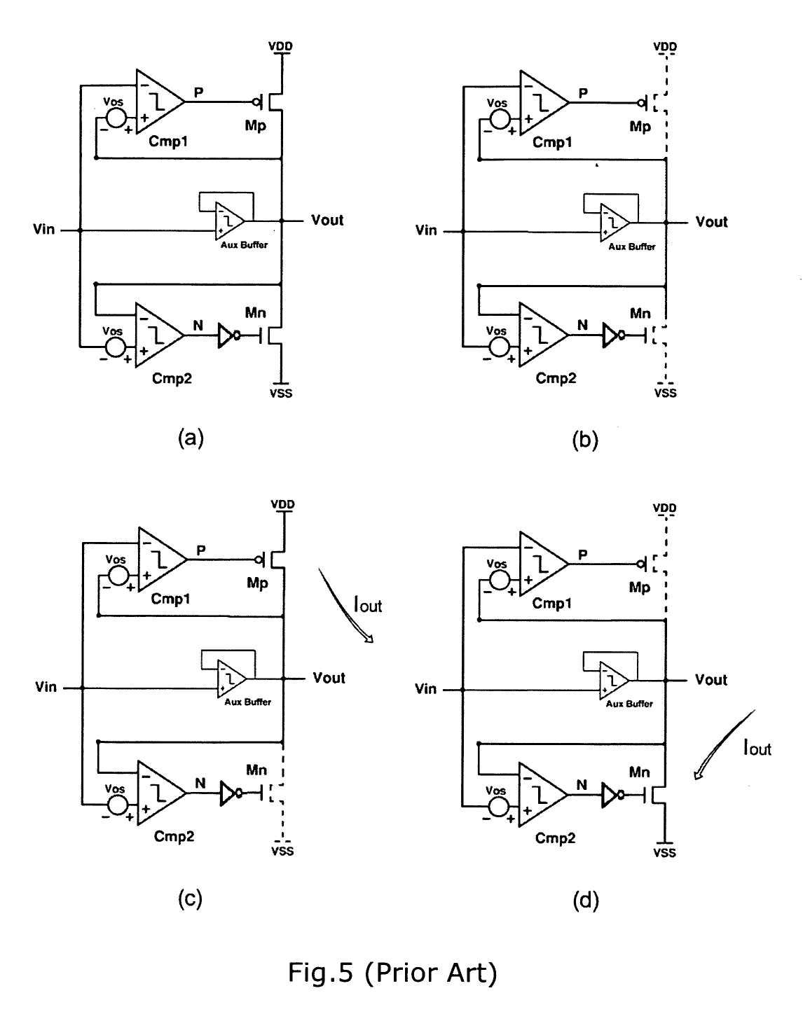

For Vin<Vout, the active Ø₁ activates the offset to pre-amplifier 101 and bias source current Ip, while the inactive Ø₂ de-activates the offset to pre-amplifier 102 and bias sink current In. Pre-amplifier 102 turns on the transistor Mn, while pre-amplifier 101 turns off the transistor Mp. Regardless of any routine process parameters variation, the activated offset voltage Vos in pre-amplifier 101 provides a safety margin to keep Mp turned off as the output voltage reaches close to, even within a small Vos range of, the input Vin level, again preventing any short-through current from occurring. The effective circuit configuration of the driver amplifier 100 becomes as shown in FIG. 3 with Mn drawing or sinking current Iout from the load (ie. the TFT's of the pixels of the LCD 904) until the output Vout reaches the level of Vin. Active bias afforded by the source current Ip keeps Vout stable and equal to Vin at steady state.

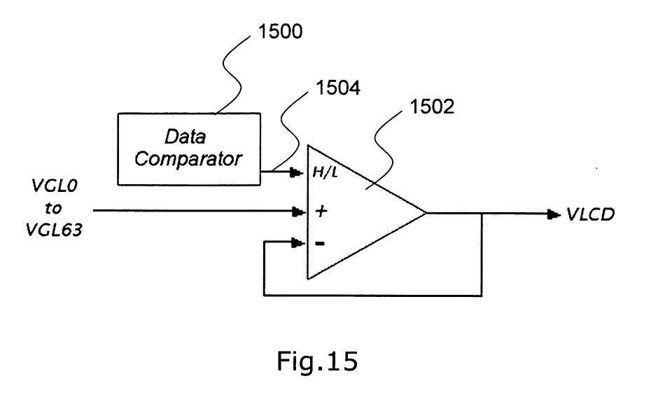

The switchable offset control signals Ø₁ and Ø₂, indicative of either Vin>Vout or Vin<Vout, are provided by either an external controller or an internal controller built into the driver amplifier 100. These controllers can be of any kind of appropriate phase detector or sensing circuit, implemented either by digital or analog approaches. FIG. 15 shows a simple schematic diagram where a data comparator 1500 outputs a switchable offset control signal 1504 to a drive amplifier 1502 configured in accordance with the drive amplifier 100 of FIG. 1. In FIG. 15, a single switching input 1504 is received from the data comparator 1500, and thus the buffer 1502 is configured internally to provide an inverted form of this input for activating the switchable offsets and the switchable current sources. Alternatively the data comparator 1500 may be formed within the drive amplifier 1502 as described above.

The switchable offset voltage Vos of the pre-amplifiers 101 and 102 may be configured in differential input circuitry of the drive amplifier 100. This may be achieved by designing small switchable asymmetries between the differentially connected input pair transistors or between the current mirror pair transistors that provide bias currents to the input pair transistors.

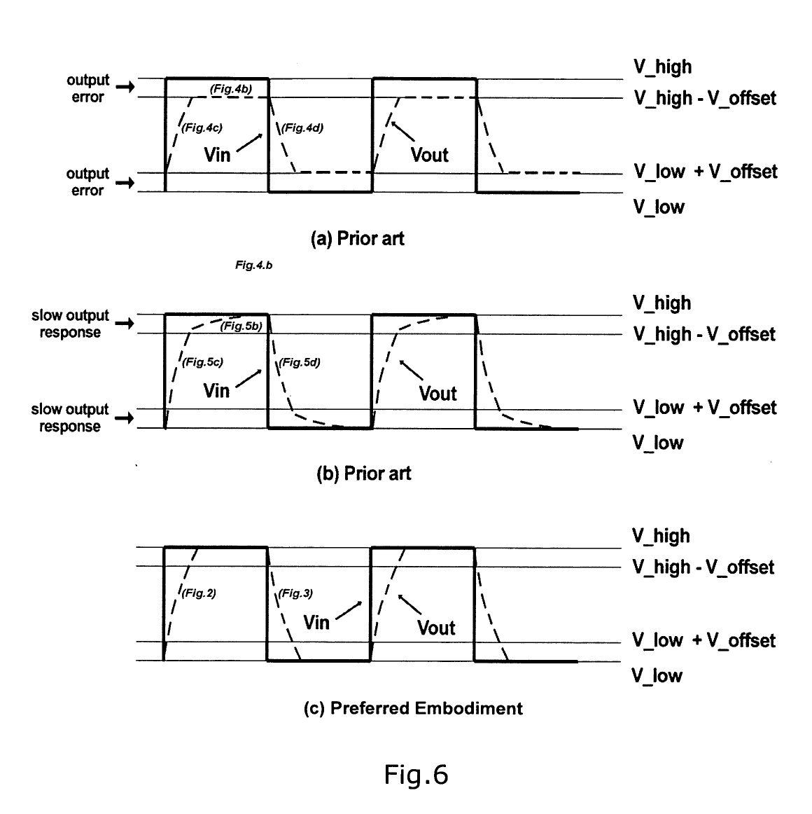

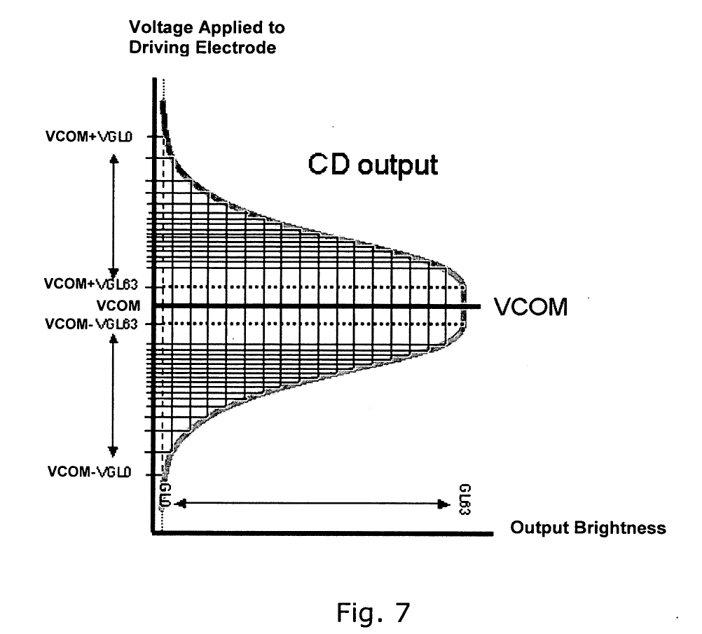

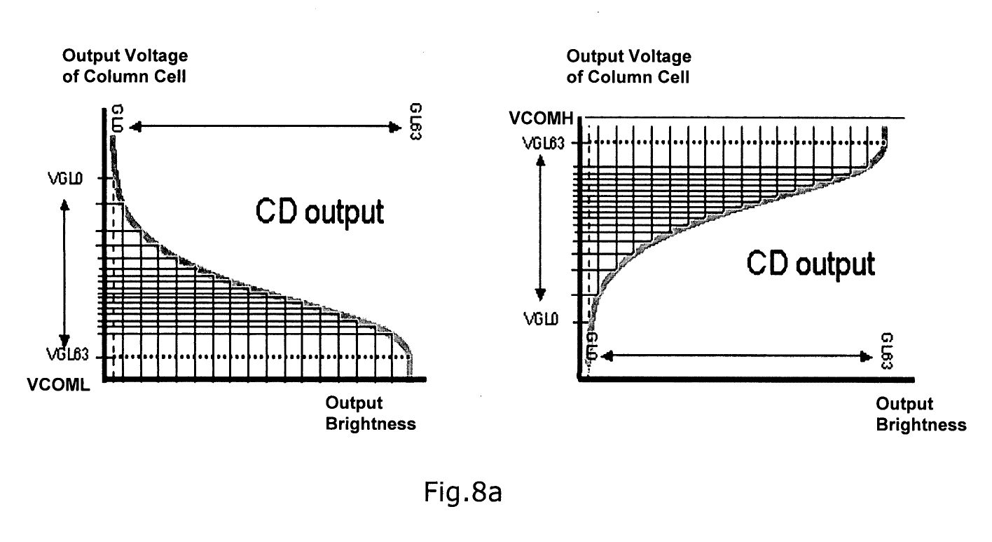

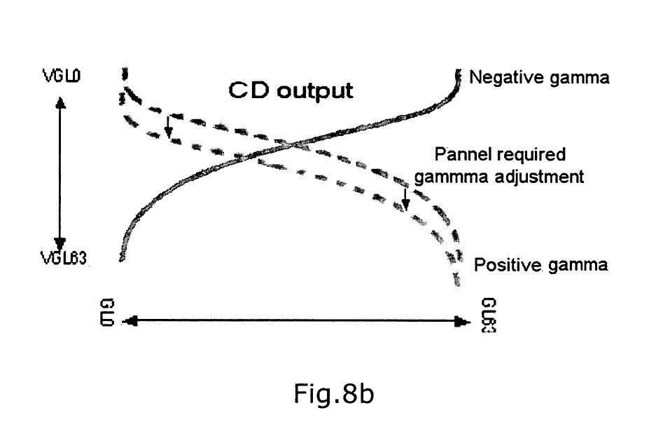

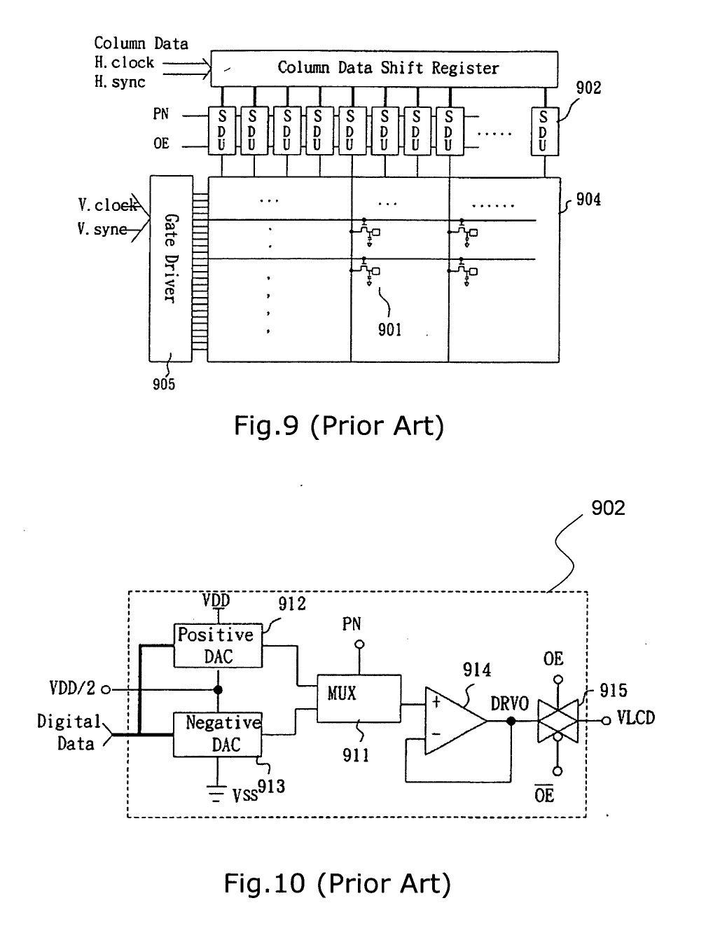

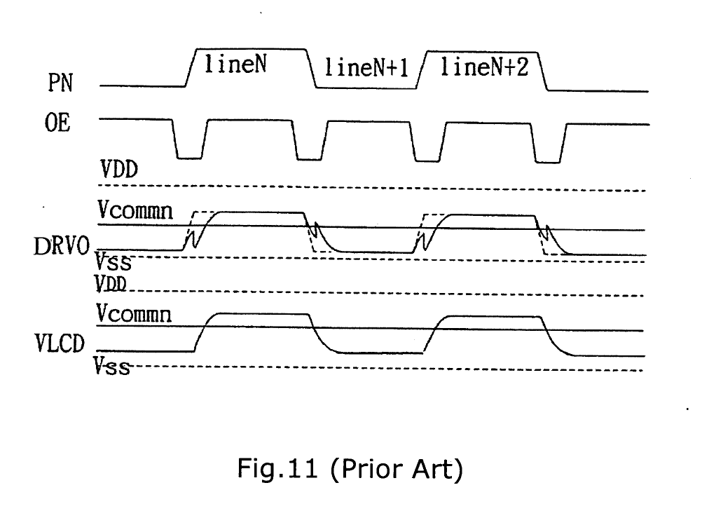

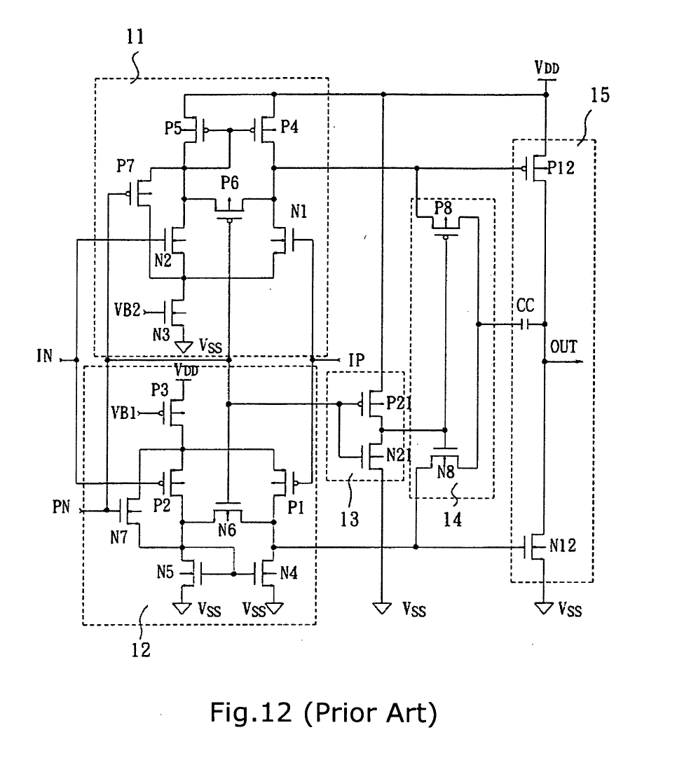

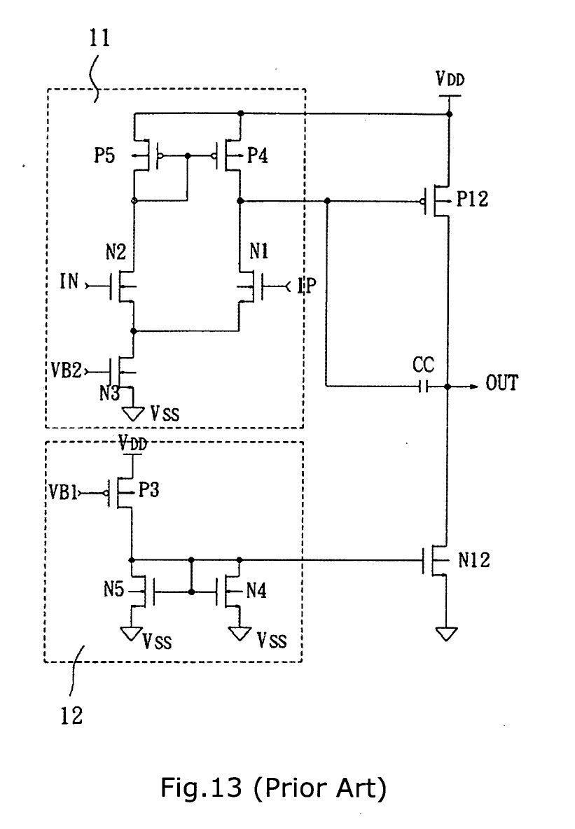

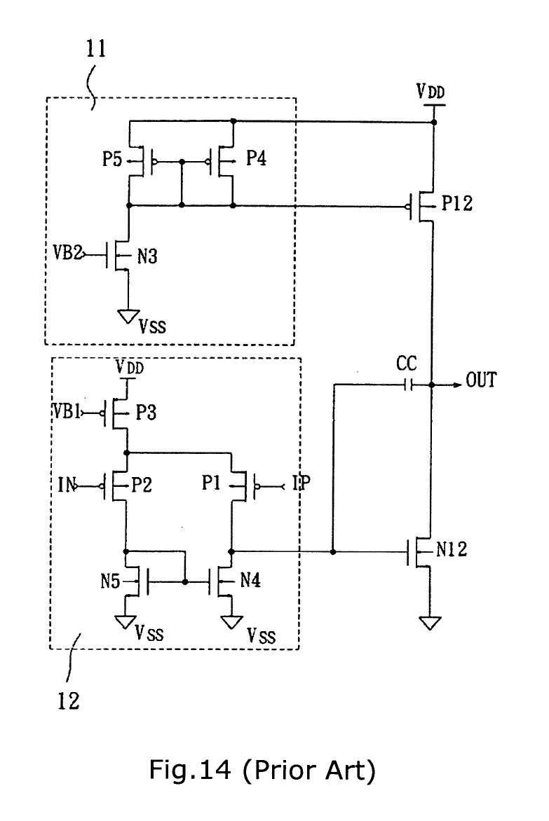

In the arrangement of FIG. 1, the circuit is configured so that only one large transistor, Mp or Mn, is turned on at any time, ensuring there is no shot-through current path through Mp to Mn in this approach. Also, since there is no deliberate offset voltage activated in the actively driving pre-amplifier, the drive amplifier 100 drives Vout to the same level as Vin with accuracy and high speed. This optimal driving ability is illustrated comparatively in FIG. 6(c) with reference to the prior art configurations discussed above.

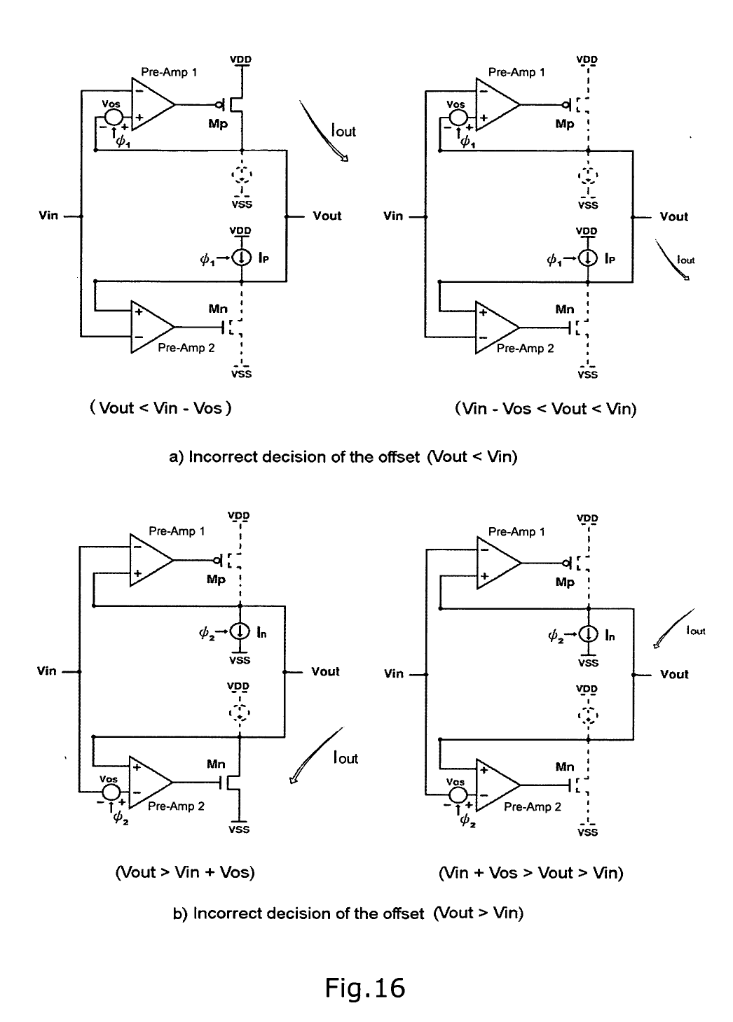

A feature of the drive amplifier 100 is the use of drive polarity control signals, such as control signals Ø₁ and Ø₂, to control switchable offsets, but not to directly control the output drive polarity. In contrast, as previously noted, prior art arrangements employ control signals to directly select the drive polarity, running into difficulties in driving schemes using charge sharing and a dynamic common electrode when the proper drive polarity cannot always be correctly determined from line data comparison alone. In the present invention, the drive polarity is always correct since it is determined by the real comparison of Vin and Vout in the differential input pre-amplifiers, ensuring that high drive is always available to quickly drive output to equal input voltage at least within the small Vos range. FIG. 16 illustrates the reduced drive situations when the output reaches within the small Vos range of Vin, in the event that an incorrect switchable Vos is activated in variant to the ideal driving situation described in details above. For Vout<Vin, a large current source output is required to charge the load capacitor presented by the TFT display to a high voltage under the ideal configuration of FIG. 2. However, as shown in FIG. 16a, assuming that a wrong decision was made by the switchable offset control signal, the transistor Mp can still source current quickly until Vin−Vos<Vout<Vin. Then the driving speed becomes slower because the output is driven by only a small bias current source Ip, when Vin−Vos<Vout<Vin. Conversely, when Vout>Vin, a large current sink capability is required for discharging the high voltage of the load capacitor under the ideal configuration in FIG. 3. However, as shown in FIG. 16b, assuming that a wrong decision was made by the switchable offset control signal, the transistor Mn can still sink current quickly until Vin+Vos>Vout>Vin. Then the driving speed becomes slower because the output is driven by only a small bias current sink In, when Vin+Vos>Vout>Vin. Experiments conducted by the present inventors indicate that the source drive amplifier disclosed herein can perform at least as well as the prior art in the worst cases depicted in FIG. 6(b), and can outperform the prior art arrangements under average conditions.

The arrangements disclosed herein offer a number of advantages, such as:

(a) the method of combining voltage offsets with output current biasing eliminates the shot-through current without tradeoff of the output accuracy;

(b) fast response or large driving capability during all conditions. Even when the switch-able offset control signal is erroneous and selects the wrong pre-amplifier to activate the purposed offset, the correct polarity high drive will still be correctly available until the output has reached to within the small range of the purposed offset from the desired input voltage;

(c) the method achieves a small circuit area, low static power consumption, high output accuracy, and large driving capability at the same time; and

(d) in steady state, the output level is not affected by any purposed or artificially induced offset voltage.

A number of features also distinguish the presently disclosed arrangements from the prior art discussed above:

(i) a switch-able small purposed offset voltage is activated in one of the two pre-amplifiers in the drive amplifier. This is seen in FIG. 2 where the offset is applied to 102, and in FIG. 3 where the offset is applied to 101;

(ii) the polarity of the high drive in the drive amplifier is determined by the pre-amplifiers sensing of the actual input and output voltages, independent of the switch-able offset control signal and thus independent of any possible error of the control signal.

(iii) The arrangement is tolerant to error in the control of the switch-able purposed offset and to absolute accuracy of the switch-able purposed offset value. As a consequence, simple purposed offset circuits, simple pre-amplifiers and simple data comparator designs are sufficient to permit implementation.

(iv) There is always one pre-amplifier without any purposed offset to sense and to bring the output voltage to be in conformance with the input voltage.

(v) At least one small current source is operative at the output node to charge and discharge the load in the steady state. This small current source will bring the output voltage to be in conformance with the input voltage regardless of the switch-able offset control signal. This is seen operative in each of FIGS. 2 and 3 for a single current source/sink. In the steady state or erroneous control situation (such as FIG. 1), both may be operative.

(vi) A previous and present line data comparator or detector or sensing circuit may be used to provide the switch-able offset control signal.

Whilst the described arrangements make use of FET technology, corresponding implementations may be formed using BIT technology, or a mix of the two.

Further the switchable offsets can be implemented at either non-inverting input or inverting input of the input differential amplifiers subject to appropriate negative feedback phasing. In this regard, the feedback signal, which is coupled between the drive amplifier output Vout and the input of pre-amplifiers, can be connected either to non-inverting input or inverting input as long as the output buffer is configured as a negative feedback system.

### INDUSTRIAL APPLICABILITY

The arrangements described are applicable to the electronic amplifier circuits, particularly push-pull drive circuits for capacitive loads. The arrangements find specific application in driver circuits for LCD displays.

The foregoing describes only some embodiments of the present invention, and modifications and/or changes can be made thereto without departing from the scope and spirit of the invention, the embodiments being illustrative and not restrictive.

We claim:

1. A drive amplifier comprising:
an output stage having an output;
pre-amplifiers having switchable offsets configured for driving the output stage from a signal input;
switchable current arrangements coupled to the output; and
at least one switching input configured to switch operation of the offsets and current arrangements.

2. A drive amplifier according to claim 1 wherein said output stage is a push-pull design having a first portion configured to supply current to the output and a second portion configured to draw current from the output, with each said portion being driven by a corresponding said pre-amplifier.

3. A drive amplifier according to claim 2, wherein said current arrangements comprise a switchable current source configured to supply current to said output and a switchable current sink configured to draw current from said output.

4. A drive amplifier according to claim 3 wherein said switchable current source is activated when the first portion is driven and the switchable current sink is activated when the second portion is driven.

5. A drive amplifier according to claim 3 wherein each said pre-amplifier has a said switchable offset, and wherein when one said pre-amplifier is driving the output stage in a corresponding one of the directions, the switchable offset of the non-driven one of said pre-amplifiers is activated.

6. A drive amplifier according to claim 5 wherein the switchable current arrangement corresponding to the driven direction is activated together with the switchable offset of the non-driving pre-amplifier.

7. A drive amplifier according to claim 1 wherein said switching input is derived from a controller formed within said amplifier.

8. A drive amplifier according to claim 1 wherein said switching input is derived from a controller external to said amplifier.

9. A drive amplifier according to claim 2 wherein the pre-amplifiers each sense a voltage of the input and a voltage of the output.

10. A source driver unit comprising a drive amplifier according to claim 1.

11. A flat panel display comprising a plurality of source driver units according to claim 10.

12. A flat panel display according to claim 11 wherein said display comprises a liquid crystal display having columns of thin film transistors, each said column being driven by a corresponding one of the source driver units.

13. A drive amplifier for a display device, said drive amplifier comprising:
a push-pull output stage having a first device for supplying current to an output and a second device for drawing current from the output;
a first pre-amplifier coupled to an input of said drive amplifier for driving said first device to supply current to the output;
a second pre-amplifier coupled to the input of said drive amplifier for driving the second device to draw current from the output
a first switchable offset associated with said first pre-amplifier and a second switchable offset associated with said second pre-amplifier;
a switchable current source configured to supply current to the output;
a switchable current sink configured to draw current from the output; and
at least one switching input configured to activate both the first switchable offset and the switchable current source, and alternately both the second switchable offset and the switchable current sink.

14. A drive amplifier according to claim 13 wherein the first pre-amplifier comprises a first input coupled to said drive amplifier input and a second input coupled to said output via said first switchable offset, and said second pre-amplifier comprises a first input coupled to said output and a second input coupled to said drive amplifier input via said second switchable offset.

15. A drive amplifier according to claim 14 wherein when one said switchable offset is not activated, the inputs of the corresponding pre-amplifier couple respectively to the drive amplifier input and the output.

16. A drive amplifier according to claim 14 wherein said switching input comprises an indication of a voltage of the output being greater than a voltage of the drive amplifier input, or the voltage of drive amplifier input being greater than the voltage of the output.

17. A drive amplifier according to claim 16 wherein said amplifier further comprises a further circuit to compare the input and output voltages and to provide the at least one switching input.

18. A drive amplifier according to claim 17 wherein said further circuit comprises a phase detector or a sensing circuit and from which is derived a complementary pair of switching inputs.

19. A source driver unit comprising a drive amplifier according to claim 13.

20. A flat panel display comprising a plurality of source driver units according to claim 19.

21. A flat panel display according to claim 20 wherein said display comprises a liquid crystal display having columns of thin film transistors, each said column being driven by a corresponding one of the source driver units.
